(19) United States
(12) Patent Application Publication
(10) Pub. No.: US 2025/0253499 A1
(43) Pub. Date: Aug. 7, 2025

(54) BATTERY

(71) Applicant: ZHUHAI COSMX BATTERY CO., LTD., Zhuhai (CN)

(72) Inventors: Xilong LI, Zhuhai (CN); Zhida WEI, Zhuhai (CN); Jichun XIE, Zhuhai (CN)

(73) Assignee: ZHUHAI COSMX BATTERY CO., LTD., Zhuhai (CN)

(21) Appl. No.: 18/979,250

(22) Filed: Dec. 12, 2024

(30) Foreign Application Priority Data
Feb. 2, 2024 (CN) 202420259683.1

(51) Int. Cl. H01M 50/531; H01M 50/543; H01M 50/569; H01M 50/586; H01M 50/636

(52) U.S. Cl. CPC H01M 50/531; H01M 50/543; H01M 50/569; H01M 50/586; H01M 50/636

(57) ABSTRACT

Disclosed is a battery. A packaging housing includes a main portion and a protruding portion. Along a first direction, the main portion includes a first end face, and the protruding portion is provided on the first end face. A first mounting cavity is provided in the main portion. A second mounting cavity in communication with the first mounting cavity is provided in the protruding portion. A projection of the protruding portion in the first direction is located in the first end face. A cell main body is arranged in the first mounting cavity. A tab assembly is connected to the cell main body and located in the second mounting cavity. A connecting assembly is disposed on the protruding portion and connected to the tab assembly. A projection of the connecting assembly in the first direction is located in the first end face.

### CROSS-REFERENCE TO RELATED APPLICATIONS

The present disclosure claims priority to Chinese Patent Application No. 202420259683.1, filed on Feb. 2, 2024, which is incorporated herein by reference in its entirety.

### TECHNICAL FIELD

The present disclosure relates to the field of electrochemical energy storage apparatus technologies, and in particular, to a battery.

### BACKGROUND

A metal shell battery (such as a steel-shell battery) is a common electrochemical energy storage apparatus, which is generally formed by a shell, a shell cover, a battery cell, a sealing piece, a welding block and the like. For the metal shell battery, positive and negative tabs are generally connected to a thickness surface of the metal shell, which is a relative narrow surface in a height direction of the metal shell, through a connecting assembly such as a connecting piece and a pole. Since a width of a conventional pole in a thickness direction of the battery is generally not too small, and when the pole is connected to the thickness surface of the metal shell, it is very difficult to make a thickness of the battery small due to the width of the pole, thus affecting application of the battery in many products.

### SUMMARY

A main objective of the present disclosure is to provide a battery to solve a problem that a thickness of the battery is difficult to reduce as mentioned in the background.

According to the first aspect of an embodiment of the present disclosure, a battery is provided, including:
a packaging housing, where the packaging housing includes a main portion and a protruding portion, along a first direction, the main portion includes a first end face, and the protruding portion is provided on the first end face in a protruding manner, where a first mounting cavity is provided in the main portion, a second mounting cavity in communication with the first mounting cavity is provided in the protruding portion, and a projection of the protruding portion in the first direction is located in the first end face;
a battery cell, where the battery cell includes a cell main body and a tab assembly, the cell main body is arranged in the first mounting cavity, and the tab assembly is connected to the cell main body and located in the second mounting cavity; and
a connecting assembly, where the connecting assembly is disposed on the protruding portion and connected to the tab assembly, and a projection of the connecting assembly in the first direction is located in the first end face.

Further, the tab assembly includes a positive tab, and the connecting assembly includes:
a pole, where the pole is disposed on the protruding portion, the pole at least partially extends to the second mounting cavity and is connected to the positive tab, and an axial direction of the pole is parallel to a second direction.

Further, the pole includes a first connection portion located in the second mounting cavity, and the connecting assembly further includes:
a first connecting piece, where the first connecting piece is arranged in the second mounting cavity, one side, in a third direction, of the first connecting piece is connected to the positive tab, the other side of the first connecting piece is connected to the first connection portion, and projections of the positive tab and the first connection portion in the second direction are staggered in the third direction.

Further, the tab assembly further includes a negative tab, and the protruding portion includes:
a first protruding portion; and
a second protruding portion, where the first protruding portion and the second protruding portion are spaced apart in a third direction, the positive tab is located in the second mounting cavity of one of the first protruding portion and the second protruding portion, and the negative tab is located in the second mounting cavity of the other one of the first protruding portion and the second protruding portion and is abutting against a cavity wall of the second mounting cavity.

Further, a mounting groove is defined by the first end face and an outer surface of the first protruding portion and the second protruding portion, and the battery further includes:
a protection circuit board, where the protection circuit board is mounted in the mounting groove and connected to the connecting assembly, and a projection, in the first direction, of the protection circuit board is located in the first end face.

Further, the protection circuit board includes:
a substrate, where two ends of the substrate in the third direction are respectively overlapped and connected with the first protruding portion and the second protruding portion and are connected to the connecting assembly; and
a mounting boss, where the mounting boss is located on a side, in the second direction, of the substrate, the mounting boss is located between the first protruding portion and the second protruding portion in the third direction, and a component is provided on the mounting boss.

Further, in the second direction, the main portion further includes a second end face, and the first protruding portion and the second protruding portion are spaced with the second end face by a predetermined distance in the second direction; and/or, the first protruding portion and the second protruding portion are located on a same horizontal plane.

Further, the predetermined distance is greater than 0.8 mm.

Further, a distance between the first protruding portion and the second protruding portion ranges from 3 mm to 5 mm.

Further, the substrate has a first extension section and a second extension section extending out of the mounting boss in a third direction, the pole further includes a second connection portion, the second connection portion is a portion located on an outer surface of the first protruding portion, and the connecting assembly further includes:
a second connecting piece, where the first extension section is overlapped and connected with the first protruding portion, one side, in the third direction, of the second connecting piece is connected to the first extension section, and the other side of the second connecting piece is connected to the second connection portion; and
a third connecting piece, where the second extension section is overlapped and connected with the second protruding portion, one side, in the third direction, of the third connecting piece is connected to the second extension section, and the other side of the third connecting piece is connected to the second connection portion.

Further, both a length of the first extension section and a length of the second extension section are not less than 0.5 mm in the third direction.

Further, the battery further includes:
a liquid injection component, where the liquid injection component is disposed in the protruding portion accommodating the negative tab, and a projection, in the first direction, of the liquid injection component is located in the first end face.

Further, the liquid injection component includes:
a liquid injection opening, where the liquid injection opening is provided in the second protruding portion and is staggered with the third connecting piece, and the liquid injection opening is in communication with the second mounting cavity of the second protruding portion; and
a sealing piece, where the sealing piece is disposed at the liquid injection opening to block the liquid injection opening.

Further, the sealing piece is at least partially connected between the third connecting piece and the second protruding portion; and/or a thickness of the third connecting piece in the second direction is less than a thickness of the sealing piece in the second direction; and/or the sealing piece and the third connecting piece are disposed in the second protruding portion in a staggered manner.

Further, the second connecting piece includes a first connecting surface and a second connecting surface, the first connecting surface is connected to the second connection portion, and the second connecting surface is connected to the first extension section. In the second direction, a distance between the first connecting surface and the second connecting surface is L1, a distance between a surface that is of the first extension section and is connected to the second connecting surface and an end face that is of the second connection portion and is close to the second connecting piece is L2, and L2 is equal to L1; and/or in the second direction, a thickness of the second connecting piece is less than a thickness of the second connection portion; and/or the third connecting piece includes a third connecting surface and a fourth connecting surface, the third connecting surface is connected to the sealing piece, and the fourth connecting surface is connected to the second extension section. In the second direction, a distance between the third connecting surface and the fourth connecting surface is L3, a distance between a surface that is of the second extension section and is connected to the fourth connecting surface and a surface that is of the sealing piece and is close to the third connecting piece is L4, and L4 is equal to L3.

Further, the connecting assembly further includes a first insulation portion and a second insulation portion, the first insulation portion is disposed between the pole and the protruding portion, and the second insulation portion is disposed between the positive tab and the packaging housing.

Further, the second insulation portion includes an insulation piece of a bending structure, and the insulation piece includes:
a body section, where the body section is disposed between the positive tab and the bottom of the second mounting cavity;
a first bending section, where the first bending section is located on a side, away from the first mounting cavity, of the body section and is bent in a direction away from the bottom of the second mounting cavity; and
a second bending section, where the second bending section is located on a side, close to the first mounting cavity, of the body section and is bent in a direction close to the bottom of the first mounting cavity.

### BRIEF DESCRIPTION OF THE DRAWINGS

The accompanying drawings described herein are intended for better understanding of the present disclosure, and constitute a part of the present disclosure. Exemplary embodiments and descriptions thereof in the present disclosure are intended to interpret the present disclosure and do not constitute any improper limitation on the present disclosure.

FIG. 1 is a schematic diagram of a structure of a battery according to an embodiment of the present disclosure.

FIG. 2 is a schematic exploded view of FIG. 1.

FIG. 3 is a schematic diagram of a structure of a bottom shell.

FIG. 4 is a front view of a battery.

FIG. 5 is a top view of a battery.

FIG. 6 is an A-A section view of FIG. 5.

FIG. 7 is an enlarged schematic diagram of part C in FIG. 6.

FIG. 8 is a schematic structural diagram of part C in FIG. 6 at a B-B section view of FIG. 5.

FIG. 9 is a schematic structural diagram of a second connecting piece.

FIG. 10 is a schematic structural diagram of a third connecting piece.

### DETAILED DESCRIPTION OF THE EMBODIMENTS

It should be noted that, without conflicts, the embodiments and features in the embodiments in the present disclosure may be combined with each other. The present application will be described in detail below with reference to the drawings and embodiments.

It should be noted that the terms used herein are merely used for describing the specific implementations, but are not intended to limit the exemplary implementations of the present disclosure. As used herein, the singular forms are intended to include the plural forms as well, unless the context clearly indicates otherwise, and also, it should be understood that when the terms “include” and/or “comprise” are used in this specification, they indicate that there are features, steps, operations, devices, elements, and/or combinations thereof.

Unless otherwise specified, relative arrangements of components and steps, numerical expressions, and numerical values set forth in these embodiments do not constitute a limitation on the scope of the present disclosure. Moreover, it should be understood that, for ease of description, sizes of various parts shown in the accompanying drawings are not drawn to scale. The technologies, methods, and devices known to those of ordinary skill in the related art may not be discussed in detail, but where appropriate, the technologies, methods, and devices should be regarded as being authorized as a part of the specification. In all examples shown and discussed herein, any specified value should be interpreted as merely illustrative, rather than restrictive. Therefore, other examples of the exemplary embodiments may have different values. It should be noted that similar reference signs and letters indicate similar items in the following drawings, and therefore once an item is defined in one drawing, it does not need to be further discussed in the subsequent drawings.

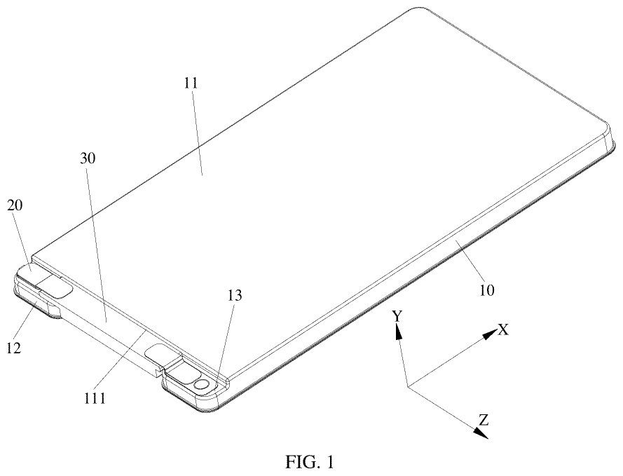

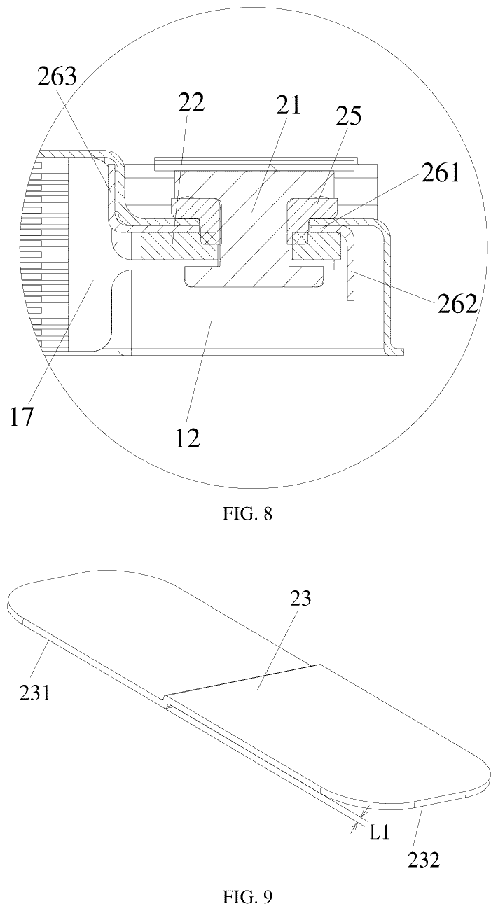

In order to solve a problem that it is difficult to reduce a battery thickness, a first embodiment of the present disclosure provides a battery. The battery includes a packaging housing 10, a battery cell, and a connecting assembly 20. Referring to FIG. 1 to FIG. 8, the packaging housing 10 includes a main portion 11 and a protruding portion. Along a first direction, the main portion 11 includes a first end face 111, and the protruding portion is provided on the first end face 111 in a protruding manner. A first mounting cavity 112 is provided in the main portion 11, a second mounting cavity 123 in communication with the first mounting cavity 112 is provided in the protruding portion. A projection of the protruding portion in the first direction is located in the first end face 111. The first direction in this embodiment is a height direction of the packaging housing 10, that is, the direction indicated by the arrow X in FIG. 1. The first end face 111 is a narrow thickness surface of the main portion 11, and the projection of the protruding portion in the first direction is located in the first end face 111, so that the thickness of the main portion 11 is not increased due to presence of the protruding portion.

The battery cell includes a cell main body 16 and a tab assembly. The cell main body 16 is disposed in the first mounting cavity 112, and the tab assembly is connected to the cell main body 16 and located in the second mounting cavity 123. That is, the second mounting cavity 123 accommodates the tab assembly, and the tab assembly does not bring an additional thickness increment to the packaging housing 10 of the battery. The connecting assembly 20 is disposed on the protruding portion and connected to the tab assembly, and a projection of the connecting assembly 20 in the first direction is located in the first end face 111. When a thickness of the first end face 111 is determined, if a width of the connecting assembly 20 is relatively large, a protrusion height of the protruding portion may be extended in the first direction to accommodate the connecting assembly 20, so as to ensure that an overall thickness of the packaging housing 10 is not affected by the width of the connecting assembly 20. Thus, a thickness of the battery can be reduced to a desired predetermined range.

It can be seen that the packaging housing 10 of the battery provided in this embodiment is provided with a protruding portion, the protruding portion is internally provided with a second mounting cavity 123 in communication with the first mounting cavity 112 of the main portion 11, and the connecting assembly 20 is disposed at the protruding portion and is connected to the tab assembly in the second mounting cavity 123. Because projections of the protruding portion and the connecting assembly 20 in the first direction are both located in a narrower end face, namely, the first end face 111, of the main portion 11, and the tab assembly and the connecting assembly 20 are accommodated in the protruding portion, the thickness of the battery will not be limited by a structure of the connecting assembly 20, thereby reducing the thickness of the battery.

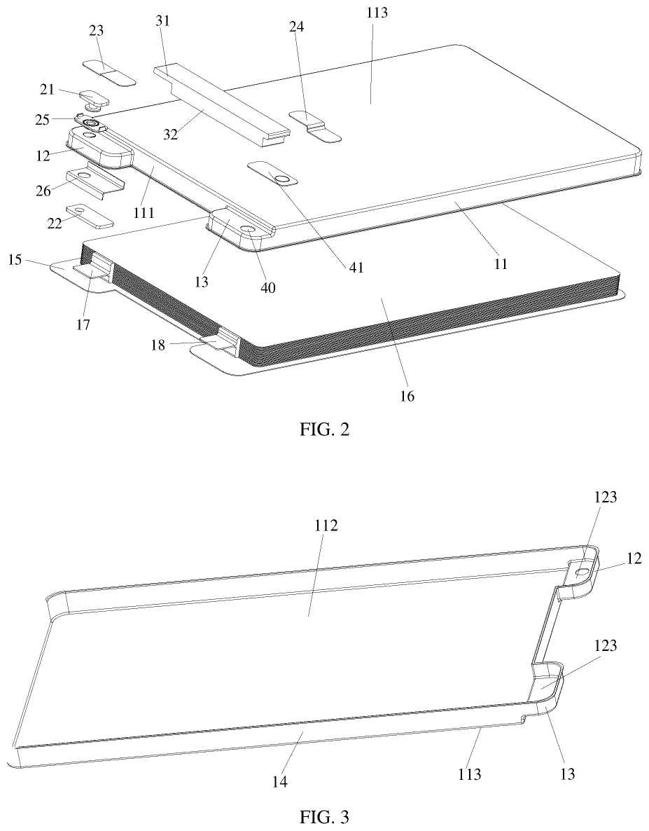

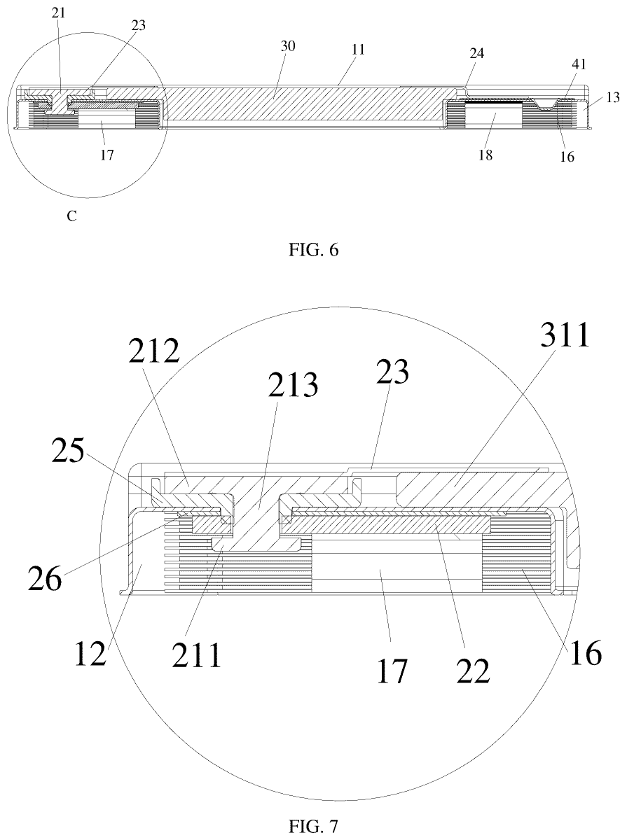

As shown in FIG. 2, FIG. 6 to FIG. 8, the tab assembly in this embodiment includes a positive tab 17, the connecting assembly 20 includes a pole 21, the pole 21 is disposed on the protruding portion, the pole 21 at least partially extends to the second mounting cavity 123 and is connected to the positive tab 17, and the axial direction of the pole 21 is parallel to a second direction. The second direction in this embodiment is the thickness direction (namely, the direction indicated by the arrow Y in FIG. 1) of the packaging housing 10 or the battery. The pole 21 in this embodiment may be a rivet structure or another connection structure that is capable of electrically connecting the positive tab 17 to an external structure. In this embodiment, when the pole 21 and the positive tab 17 are connected, the width of the pole 21 in the first direction is accommodated in the protruding portion by making the axial direction of the tab parallel to the thickness direction of the battery, so as to prevent the thickness of the battery from increasing due to an increase of the width of the pole 21. In order to enhance connection firmness between the pole 21 and the protruding portion, when the width of the pole 21 is required to be increased, a protruding height of the protruding portion protruding from the first end face 111 in the first direction is correspondingly increased, so as to always ensure that the protruding portion can accommodate the pole 21 without increasing the thickness of the battery, thereby greatly reducing difficulty in thinning the battery.

The pole 21 in this embodiment includes a first connection portion 211 located in the second mounting cavity 123, the connecting assembly 20 further includes a first connecting piece 22, and the first connecting piece 22 is disposed in the second mounting cavity 123. As shown in FIG. 7, one side, in a third direction, of the first connecting piece 22 is connected to the positive tab 17, the other side of the first connecting piece 22 is connected to the first connection portion 211, and projections of the positive tab 17 and the first connection portion 211 in the second direction are staggered in the third direction. In this embodiment, when the positive tab 17 and the first connection portion 211 of the pole 21 are connected through the first connecting piece 22, in order to further reduce the thickness of the protruding portion in the second direction and/or a thickness of the whole battery in the second direction, the positive tab 17 and the first connection portion 211 are connected to the first connecting piece 22 in a staggered manner in the third direction, so as to ensure that the positive tab 17 and the first connection portion 211 are not aligned, thereby reducing a thickness of a portion formed when the pole 21 and the positive tab 17 are connected. When the thickness of the portion formed when the pole 21 and the positive tab 17 are connected is reduced, the thickness of the protruding portion and the battery portion 11 may be reduced.

As shown in FIG. 2 and FIG. 6, the tab assembly in this embodiment further includes a negative tab 18, and the protruding portion includes a first protruding portion 12 and a second protruding portion 13. The first protruding portion 12 and the second protruding portion 13 are spaced apart in a third direction, the positive tab 17 is located in the second mounting cavity 123 of one of the first protruding portion 12 and the second protruding portion 13, and the negative tab 18 is located in the second mounting cavity 123 of the other one of the first protruding portion 12 and the second protruding portion 13 and is abutting against a cavity wall of the second mounting cavity 123. The third direction in this embodiment is a width direction of the packaging housing 10, that is, the direction indicated by the arrow Z in FIG. 1. In this embodiment, the positive tab 17 may be accommodated by the second mounting cavity 123 in the first protruding portion 12 to construct a positive electrode electronic channel of the battery. The negative tab 18 is accommodated by the second mounting cavity 123 of the second protruding portion 13 to construct a negative electrode electronic channel of the battery. Volumes of the second mounting cavity 123 of the first protruding portion 12 and the second mounting cavity 123 of the second protruding portion 13 can completely accommodate the positive tab 17 and the negative tab 18 respectively. After the positive tab 17 and the negative tab 18 are respectively accommodated in corresponding second mounting cavities 123, the positive tab 17 and the negative tab 18 bring no additional thickness increment to the packaging housing 10 of the battery.

During use of the battery, over-charging, over-discharging, short circuit and over-current all affect the service life and performance of the battery, or even cause the battery to burn and explode. Thus, a protection circuit board 30 is typically mounted on the battery. The protection circuit board 30 can effectively monitor and prevent dangers such as burning and explosion caused by over-charging, over-discharging and short circuit of the battery, thereby protecting the battery. In view of this, in a case that the thickness of the battery provided in this embodiment is thinned, to maximize utilization of space of the packaging housing 10 and prevent the thickness of the battery from being increased after the protection circuit board 30 is installed, a mounting groove is defined along the first end face 111 and an outer surface of the first protruding portion 12 and the second protruding portion 13 in this embodiment. The protection circuit board 30 provided in this embodiment is mounted in the mounting groove and connected to the connecting assembly 20, and a projection, in the first direction, of the protection circuit board 30 is located in the first end face 111. Therefore, after the protection circuit board 30 is mounted on the battery, the protection circuit board 30 is accommodated by making full use of space between the first protruding portion 12 and the second protruding portion 13 in the third direction and enclosed by the protruding portions and the main portion 11 in the second direction in this embodiment. In this way, a projection of the protection circuit board 30 in the first direction is also located in the first end face 111, which ensures that the battery does not have a thickness increment due to existence of the protection circuit board 30, and expands application of the battery in more products with limited mounting grooves.

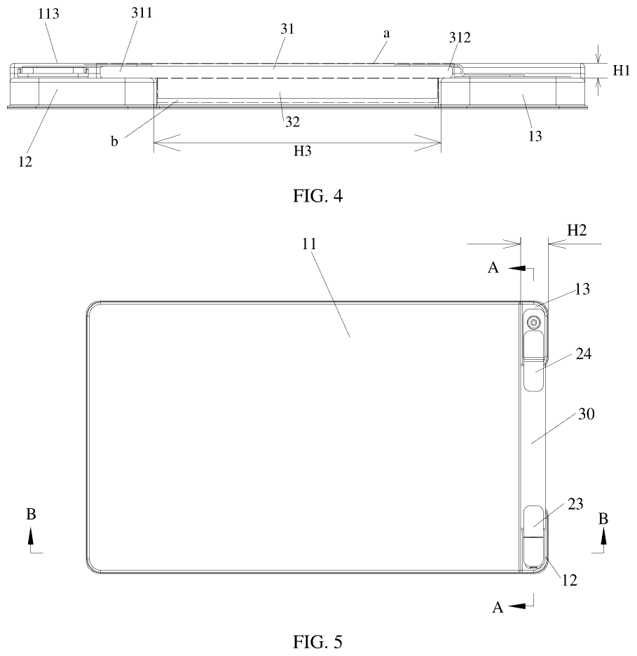

As shown in FIG. 2 and FIG. 4, the protection circuit board 30 includes a substrate 31 and a mounting boss 32. Two ends of the substrate 31 in the third direction are respectively overlapped and connected with the first protruding portion 12 and the second protruding portion 13 and are connected to the connecting assembly 20. The mounting boss 32 is located on a side, in the second direction, of the substrate 31, the mounting boss 32 is located between the first protruding portion 12 and the second protruding portion 13 in the third direction, and a component is provided on the mounting boss 32. According to the mounting groove formed between the first protruding portion 12 and the second protruding portion 13 and the main portion 11 in this embodiment, a structure of the protection circuit board 30 is configured to match the mounting groove. In view of this, the protection circuit board 30 is mainly formed by the substrate 31 that is a relatively thin in thickness in the second direction and the mounting boss 32 that is relatively thick with respect to the substrate 31. The mounting boss 32 and a component disposed thereon are mounted and accommodated in a space between the first protruding portion 12 and the second protruding portion 13 in the second direction, and the substrate 31 is accommodated on a side of the protruding portion along the second direction, thereby maximizing utilization of a mounting groove formed between the main portion 11 and the protruding portion, and improving energy density of the battery.

Specifically, the mounting groove in this embodiment includes a first mounting area (namely, the area where a dashed box a is located in FIG. 4) and a second mounting area (namely, the area where a dashed box b is located in FIG. 4). In the second direction, the main portion 11 further includes a second end face 113. The first protruding portion 12 and the second protruding portion 13 are spaced with the second end face 113 by a predetermined distance (namely, the distance indicated by H1 in FIG. 4) in the second direction. Thus, a first mounting area of the mounting groove is formed between the second end face 113 and the first and second protruding portions 12, 13. A space between the first protruding portion 12 and the second protruding portion 13 in the third direction forms a second mounting area of the mounting groove. The first mounting area is used to accommodate the connecting assembly 20 and the substrate 31 of the protection circuit board 30, and the second mounting area is used to accommodate the mounting boss 32 of the protection circuit board 30 and a component on the mounting boss 32, thereby maximizing utilization of the mounting groove on the battery. The first protruding portion 12 and the second protruding portion 13 may be located on a same horizontal plane, so as to further improve full utilization of the space in which the first end face 111 of the main portion 11 is located. Thus, the first protruding portion 12 and the second protruding portion 13 will not cause an increase in thickness of the battery, and also form a larger mounting groove with the main portion 11 to achieve installation and accommodation of the connecting assembly 20 and the protection circuit board 30.

Specifically, as shown in FIG. 2 and FIG. 3, the packaging shell 10 in this embodiment is formed by a bottom housing 14 and a cover plate 15. An area of the bottom housing 14 located in the main portion 11 is provided with a recess serving as a first mounting cavity 112 in the second direction, and an area of the bottom housing 14 located in the protruding portion is provided with a recess serving as the second mounting cavity 123. After the battery cell is mounted in the first mounting cavity 112, the cover plate 15 covers the recess provided in the bottom housing 14. In the case that the protruding portion includes the first protruding portion 12 and the second protruding portion 13, the first protruding portion 12 and the second protruding portion 13 are located on a same horizontal plane and flush with a side, close to the cover plate 15, of the bottom housing 14. The second end face 113 of the main portion 11 has a height difference (namely, the predetermined distance) in the second direction with the first protruding portion 12 and the second protruding portion 13, and the height difference is greater than 0.8 mm. Due to presence of the height difference between the protruding portions and the main portion 11, the first mounting area capable of accommodating the substrate 31 of the protection circuit board 30 and the connecting assembly 20 is formed. Specifically, a numerical value of the height difference includes one of 0.9 mm, 1 mm, 1.1 mm, 1.2 mm, 1.3 mm, 1.4 mm, 1.5 mm, or the like.

In addition, in the first direction, a distance between the first end face 111 and an end, away from the first end face 111 of the main portion 11, of the protruding portion in this embodiment is greater than 2 mm (namely, the distance indicated by H2 in FIG. 5), so as to reserve enough mounting width for the connecting assembly 20, and ensure that the protruding portions and the second mounting cavity 123 therein can accommodate the tab assembly and the connecting assembly 20. Specifically, the distance between the first end face 111 and an end, away from the first end face 111 of the main portion 11, of the protruding portion has one of numerical values of 2.1 mm, 2.2 mm, 2.3 mm, 2.4 mm, 2.5 mm, 2.6 mm, or the like.

A distance between the first protruding portion 12 and the second protruding portion 13 (namely, the distance indicated by H3 in FIG. 4) ranges from 3 mm to 5 mm. In other words, a length of the second mounting area in the third direction ranges from 3 mm to 5 mm, so that the second mounting area can fully accommodate the mounting boss 32 of the protection circuit board 30 and a component thereon. Specifically, the length of the second mounting area in the third direction has one of numerical values of 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, or the like.

As shown in FIG. 4, the substrate 31 of the protection circuit board 30 has a first extension section 311 and a second extension section 312 extending out of the mounting boss 32 in a third direction, that is, the first extension section 311 and the second extension section 312 are respectively located on two opposite sides of the mounting boss 32 in the third direction. The pole 21 in this embodiment further includes a second connection portion 212, and the second connection portion 212 is a portion located on an outer surface of the first protruding portion 12. As shown in FIG. 7, the pole 21 further includes a third connection portion 213 of a columnar structure, one end of the third connection portion 213 is connected to the second connection portion 212, and the other end of the third connection portion 213 is connected to the first connection portion 211. One end, away from the second connection portion 212, of the third connection portion 213 extends into the second mounting cavity 123 where the positive tab 17 is located, so that the first connection portion 211 is connected to the positive tab 17 and the first connecting piece 22. The connecting assembly 20 in this embodiment further includes a second connecting piece 23 and a third connecting piece 24. The first extension section 311 of the substrate 31 is overlapped and connected with the first protruding portion 12. One side, in the third direction, of the second connecting piece 23 is connected to the first extension section 311, and the other side of the second connecting piece 23 is connected to the second connection portion 212. The second extension section 312 of the substrate 31 is overlapped and connected with the second protruding portion 13. One side, in the third direction, of the third connecting piece 24 is connected to the second extension section 312, and the other side of the third connecting piece 24 is connected to the second protruding portion 13. The substrate 31 is firmly and stably mounted on the protruding portion through the first extension section 311 and the second extension section 312, and brings no additional thickness increment to the battery.

In the third direction, a length of the first extension section 311 and a length of the second extension section 312 are both not less than 0.5 mm (that is, greater than or equal to 0.5 mm). The length of the first extension section 311 and the length of the second extension section 312 may specifically has one of numerical values such as 0.5 mm, 0.6 mm, 0.7 mm, 0.8 mm, 0.9 mm, 1 mm, 1.2 mm, 1.3 mm, or the like, so that the first extension section 311 and the second extension section 312 can be overlapped and connected with corresponding protruding portions to ensure stable connection between the substrate 31 and the packaging housing 10.

The battery in this embodiment further includes a liquid injection component disposed on a protruding portion having a negative tab 18. A projection of the liquid injection component in the first direction is located in the first end face 111, so that the thickness of the battery is not increased due to presence of the liquid injection component. For example, in this embodiment, when the negative tab 18 is disposed on the second protruding portion 13, the liquid injection component is disposed at the second protruding portion 13 where the negative tab 18 is located, so as to inject an electrolyte solution into the battery from the second protruding portion 13. Since the second mounting cavity 123 of the second protruding portion 13 mainly accommodates the negative tab 18 and still has a large remaining space, the second mounting cavity 123 of the second protruding portion 13 may also be used as liquid storage space for the electrolyte solution while accommodating the negative tab 18, so that more electrolyte solution can be stored in the battery. A large amount of electrolyte solution is beneficial to improving cycle life of the battery.

As shown in FIG. 2 and FIG. 6, the liquid injection component in this embodiment includes a liquid injection opening 40 and a sealing piece 41. A projection of the sealing piece 41 in the first direction is located in the first end face 111. A width of the sealing piece 41 in the first direction is less than a width of the protruding portion in the first direction, and a length of the sealing piece 41 in the third direction is less than a length of the protruding portion in the third direction. The liquid injection opening 40 is provided in the second protruding portion 13 and is staggered with the third connecting piece 24, so that the third connecting piece 24 is prevented from interfering with the liquid injection opening 40, thereby improving convenience of the liquid injection operation and liquid injection efficiency. In addition, the liquid injection opening 40 is in communication with the second mounting cavity 123 of the second protruding portion 13, so that the electrolyte solution may be injected into the packaging housing 10 through the liquid injection opening 40. The sealing piece 41 is disposed at the liquid injection opening 40 and is used to block the liquid injection opening 40, so that the liquid injection opening 40 is blocked by the sealing piece 41 to prevent liquid leakage after the liquid injection is completed.

The sealing piece 41 of the liquid injection component is at least partially connected (a connection manner shown in FIG. 6) between the third connecting piece 24 and the second protruding portion 13, and a thickness of the third connecting piece 24 in the second direction is less than a thickness of the sealing piece 41 in the second direction, so that the sealing piece 41 is not easily welded through to cause liquid leakage while the third connecting piece 24 is firmly welded to the sealing piece 41. In this embodiment, the sealing piece 41 and the third connecting piece 24 are arranged in a staggered manner on the second protruding portion 13, that is, in this embodiment, a length of the sealing piece 41 in the third direction can be shortened, and the third connecting piece 24 is directly welded to the second protruding portion 13, so that projections of the third connecting piece 24 and the sealing piece 41 in the second direction are not overlapped, thereby further reducing an overall thickness, in the second direction, of the second protruding portion 13 connected with the third connecting piece 24 and the sealing piece 41, and further reducing a thickness of the whole battery in the second direction.

The second connecting piece 23 and the third connecting piece 24 in this embodiment are both of a bent sheet structure. As shown in FIG. 9, the second connecting piece 23 includes a first connecting surface 231 and a second connecting surface 232. The first connecting surface 231 is connected to the second connection portion 212, and the second connecting surface 232 is connected to the first extension section 311. In the second direction, a distance between the first connecting surface 231 and the second connecting surface 232 is L1 (namely, a height of a step formed between the first connecting surface 231 and the second connecting surface 232 in the second direction), a distance between a surface that is of the first extension section 311 and is connected to the second connecting surface 232 and an end face that is of the second connection portion 212 and is close to the second connecting piece 23 is L2, and L2 is equal to L1. In other words, the step height L1 of a bending step of the second connecting piece 23 is equal to a distance between a surface, close to the first end face 111 of the main portion 11, of the first extension section 311 of the substrate 31 and a surface of the second connection portion 212 of the pole 21. With the distance L1, the second connecting piece 23 can effectively and firmly connect the first extension section 311 of the substrate 31 with the second connection portion 212 of the pole 21. In the second direction, a thickness of the second connecting piece 23 is less than a thickness of the second connection portion 212. The thickness of the second connecting piece 23 is small, so that the second connection portion 212 is not prone to being welded through to cause liquid leakage while the second connecting piece 23 is firmly welded with the second connection portion 212, thereby improving structural strength of the packaging housing 10.

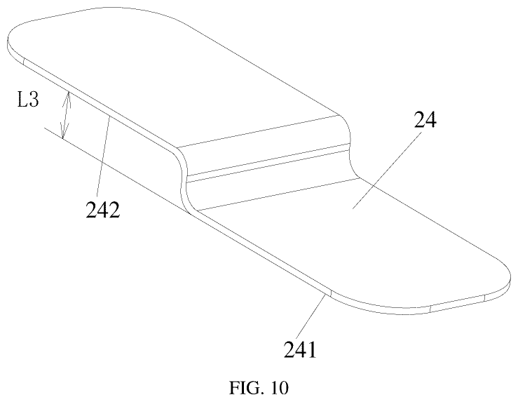

As shown in FIG. 10, when the third connecting piece 24 is of a bent sheet structure, the third connecting piece 24 includes a third connecting surface 241 and a fourth connecting surface 242. The third connecting surface 241 is connected to the sealing piece 41, and the fourth connecting surface 242 is connected to the second extension section 312. In the second direction, a distance between the third connecting surface 241 and the fourth connecting surface 242 is L3, a distance between a surface that is of the second extension section 312 and is connected to the fourth connecting surface 242 and a surface that is of the sealing piece 41 and is close to the third connecting piece 24 is L4, and L4 is equal to L3. In other words, a step height L2 of a bending step of the third connecting piece 24 is equal to a distance between a surface of the sealing piece 41 and a surface that is of the second extension section 312 of the substrate 31 and is close to the first end face 111 of the main portion 11, so that the third connecting piece 24 can effectively and firmly connect the second extension section 312 of the substrate 31 to the sealing piece 41.

The connecting assembly 20 in this embodiment further includes a first insulation portion 25 and a second insulation portion 26. The first insulation portion 25 is disposed between the pole 21 and a protruding portion, and the second insulation portion 26 is disposed between the positive tab 17 and the packaging housing 10. Specifically, when the positive tab 17 is disposed on the first protruding portion 12, the first insulation portion 25 is disposed between the second connection portion 212 of the pole 21 and the surface of the first protruding portion 12, and the second insulation portion 26 is disposed between the first connecting piece 22 connected to the positive tab 17 and an inner wall surface of the first protruding portion 12, so as to isolate the positive electrode plate from the packaging housing 10.

The second insulation portion 26 includes an insulation piece of a bending structure, and the insulation piece includes a body section 261, a first bending section 262, and a second bending section 263. The body section 261 is disposed between the positive tab 17 and the bottom of the second mounting cavity 123. Specifically, the body section 261 is disposed between the first connecting piece 22 and the bottom of the second mounting cavity 123 to isolate a side, connected to the first connecting piece 22, of the positive tab 17 and the first connecting piece 22 from the packaging housing 10. The first bending section 262 is located on a side, away from the first mounting cavity 112, of the body section 261 and is bent in a direction away from the bottom of the second mounting cavity 123. The first bending section 262 is configured to isolate the positive tab 17 and a side, away from the first mounting cavity 112, of the first connecting piece 22 from the packaging housing 10. The second bending section 263 is located on a side, close to the first mounting cavity 112, of the body section 261 and is bent in a direction close to the bottom of the first mounting cavity 112. The second bending section 263 is configured to isolate a portion, located in the first mounting cavity 112, of the positive tab 17 from the packaging housing 10.

It can be seen from the above that the packaging housing 10 of the battery in this embodiment has a protruding portion for accommodating the tab assembly and the connecting assembly 20, the cell main body 16 of the battery cell is disposed in the first mounting cavity 112 of the packaging housing 10, the tab assembly is connected to the cell main body 16 and located in the second mounting cavity 123 of the protruding portion, and the tab assembly is pressed tightly against the packaging housing 10 and then welded to the packaging housing 10. The protruding portion includes a first protruding portion 12 accommodating the positive tab 17 and a second protruding portion 13 accommodating the negative tab 18. According to the embodiment, an electrolyte solution is injected into the packaging housing 10 from the second protruding portion 13, the remaining area of the second mounting cavity 123 of the second protruding portion 13 accommodating the negative tab 18 is used to provide a temporary storage space for the electrolyte solution. which not only optimizes performance of a liquid injection process, but also optimizes cycling performance of the battery. The protection circuit board 30 of the battery is disposed in a mounting groove between the first protruding portion 12, the second protruding portion 13 and the main portion 11 for connection, so as to maximize utilization of space of a battery compartment by designing dimensions of the first protruding portion 12 and the second protruding portion 13 to be consistent with an external dimension of the protection circuit board 30.

For ease of description, spatially relative terms such as “on”, “above”, “on the surface of”, and “over” may be used herein to describe a spatial positional relationship between one means or feature and another means or feature shown in the drawings. It should be understood that the spatially relative terms are intended to encompass different orientations in use or operation other than the orientation of the means described in the drawings. For example, if the means in the drawing are inverted, a means described as “above other means or structures” or “on other means or structures” then is positioned as “below other means or structures” or “under other means or structures”. Thus, the exemplary term “on” may include both orientations of being “on” and “below”. The means may also be positioned in other different ways (rotated by 90° or in another orientation) and the spatially relative description used herein will be explained accordingly.

In addition, it should be noted that, terms such as “first” and “second” are used to define parts only for convenience of distinguishing between corresponding parts, the described terms do not have special meanings unless stated otherwise, and therefore cannot be understood as a limitation of protection scope of the present disclosure.

The foregoing descriptions are merely some embodiments of the present disclosure, but are not intended to limit the present disclosure. Persons skilled in the art understand that the present disclosure may have various modifications and variations. Any modification, equivalent replacement, or improvement made without departing from the spirit and principle of the present disclosure shall fall within the protection scope of the present disclosure.

What is claimed is:

1. A battery, comprising:
a packaging housing, wherein the packaging housing comprises a main portion and a protruding portion, along a first direction, the main portion comprises a first end face, and the protruding portion is provided on the first end face in a protruding manner, a first mounting cavity is provided in the main portion, a second mounting cavity in communication with the first mounting cavity is provided in the protruding portion, and a projection of the protruding portion in the first direction is located in the first end face;
a battery cell, wherein the battery cell comprises a cell main body and a tab assembly, the cell main body is arranged in the first mounting cavity, and the tab assembly is connected to the cell main body and located in the second mounting cavity; and
a connecting assembly, wherein the connecting assembly is disposed on the protruding portion and connected to the tab assembly, and a projection of the connecting assembly in the first direction is located in the first end face.

2. The battery according to claim 1, wherein the tab assembly comprises a positive tab, and the connecting assembly comprises:
a pole, wherein the pole is disposed on the protruding portion, the pole at least partially extends to the second mounting cavity and is connected to the positive tab, and an axial direction of the pole is parallel to a second direction.

3. The battery according to claim 2, wherein the pole comprises a first connection portion located in the second mounting cavity, and the connecting assembly further comprises:
a first connecting piece, wherein the first connecting piece is arranged in the second mounting cavity, one side, in a third direction, of the first connecting piece is connected to the positive tab, the other side of the first connecting piece is connected to the first connection portion, and projections of the positive tab and the first connection portion in the second direction are staggered in the third direction.

4. The battery according to claim 2, wherein the tab assembly further comprises a negative tab, and the protruding portion comprises:
a first protruding portion; and
a second protruding portion, wherein the first protruding portion and the second protruding portion are spaced apart in a third direction, the positive tab is located in the second mounting cavity of one of the first protruding portion and the second protruding portion, and the negative tab is located in the second mounting cavity of the other one of the first protruding portion and the second protruding portion and is abutting against a cavity wall of the second mounting cavity.

5. The battery according to claim 4, wherein a mounting groove is defined by the first end face and an outer surface of the first protruding portion and the second protruding portion, and the battery further comprises:
a protection circuit board, wherein the protection circuit board is mounted in the mounting groove and connected to the connecting assembly, and a projection, in the first direction, of the protection circuit board is located in the first end face.

6. The battery according to claim 5, wherein the protection circuit board comprises:
a substrate, wherein two ends of the substrate in the third direction are respectively overlapped and connected with the first protruding portion and the second protruding portion and are connected to the connecting assembly; and
a mounting boss, wherein the mounting boss is located on a side, in the second direction, of the substrate, the mounting boss is located between the first protruding portion and the second protruding portion in the third direction, and a component is provided on the mounting boss.

7. The battery according to claim 4, wherein in the second direction, the main portion further comprises a second end face, and the first protruding portion and the second protruding portion are spaced with the second end face by a predetermined distance; and/or, the first protruding portion and the second protruding portion are located on a same horizontal plane.

8. The battery according to claim 7, wherein the predetermined distance is greater than 0.8 mm.

9. The battery according to claim 4, wherein a distance between the first protruding portion and the second protruding portion ranges from 3 mm to 5 mm.

10. The battery according to claim 6, wherein the substrate has a first extension section and a second extension section extending out of the mounting boss in a third direction, the pole further comprises a second connection portion, the second connection portion is a portion located on an outer surface of the first protruding portion, and the connecting assembly further comprises:
a second connecting piece, wherein the first extension section is overlapped and connected with the first protruding portion, one side, in the third direction, of the second connecting piece is connected to the first extension section, and the other side of the second connecting piece is connected to the second connection portion; and
a third connecting piece, wherein the second extension section is overlapped and connected with the second protruding portion, one side, in the third direction, of the third connecting piece is connected to the second extension section, and the other side of the third connecting piece is connected to the second connection portion.

11. The battery according to claim 10, wherein both a length of the first extension section and a length of the second extension section are not less than 0.5 mm in the third direction.

12. The battery according to claim 10, wherein the battery further comprises:
a liquid injection component, wherein the liquid injection component is disposed in the protruding portion accommodating the negative tab, and a projection, in the first direction, of the liquid injection component is located in the first end face.

13. The battery according to claim 12, wherein the liquid injection component further comprises:
a liquid injection opening, wherein the liquid injection opening is provided in the second protruding portion and is staggered with the third connecting piece, and the liquid injection opening is in communication with the second mounting cavity of the second protruding portion; and
a sealing piece, wherein the sealing piece is disposed at the liquid injection opening.

14. The battery according to claim 13, wherein the sealing piece is at least partially connected between the third connecting piece and the second protruding portion; and/or a thickness of the third connecting piece in the second direction is less than a thickness of the sealing piece in the second direction; and/or the sealing piece and the third connecting piece are disposed in the second protruding portion in a staggered manner.

15. The battery according to claim 14, wherein the second connecting piece comprises a first connecting surface and a second connecting surface, the first connecting surface is connected to the second connection portion, and the second connecting surface is connected to the first extension section; in the second direction, a distance between the first connecting surface and the second connecting surface is L1, a distance between a surface that is of the first extension section and is connected to the second connecting surface and an end face that is of the second connection portion and is close to the second connecting piece is L2, and L2 is equal to L1; and/or in the second direction, a thickness of the second connecting piece is less than a thickness of the second connection portion; and/or the third connecting piece comprises a third connecting surface and a fourth connecting surface, the third connecting surface is connected to the sealing piece, and the fourth connecting surface is connected to the second extension section; and in the second direction, a distance between the third connecting surface and the fourth connecting surface is L3, a distance between a surface that is of the second extension section and is connected to the fourth connecting surface and a surface that is of the sealing piece and is close to the third connecting piece is L4, and L4 is equal to L3.

16. The battery according to claim 2, wherein the connecting assembly further comprises a first insulation portion and a second insulation portion, the first insulation portion is disposed between the pole and the protruding portion, and the second insulation portion is disposed between the positive tab and the packaging housing.

17. The battery according to claim 16, wherein the second insulation portion comprises an insulation piece of a bending structure, and the insulation piece comprises:
a body section, wherein the body section is disposed between the positive tab and the bottom of the second mounting cavity;
a first bending section, wherein the first bending section is located on a side, away from the first mounting cavity, of the body section and is bent in a direction away from the bottom of the second mounting cavity; and
a second bending section, wherein the second bending section is located on a side, close to the first mounting cavity, of the body section and is bent in a direction close to the bottom of the first mounting cavity.
